(19) United States
(12) Patent Application Publication
(10) Pub. No.: US 2011/0200879 A1
(43) Pub. Date: Aug. 18, 2011

(54) NON-AQUEOUS ELECTROLYTE SECONDARY BATTERY AND METHOD OF MANUFACTURING THE SAME

(75) Inventors: Motoharu Saito, Kobe-shi (JP); Masahisa Fujimoto, Osaka (JP)

(73) Assignee: SANYO ELECTRIC CO., LTD., Osaka (JP)

(21) Appl. No.: 13/025,442

(22) Filed: Feb. 11, 2011

(30) Foreign Application Priority Data
Feb. 16, 2010 (JP) 2010-031265

(51) Int. Cl. H01M 4/505; H01M 4/131; H01M 4/139; H01M 4/525; H01M 4/88

(52) U.S. Cl. 429/221; 429/224; 429/223; 252/182.1

(57) ABSTRACT

A non-aqueous electrolyte secondary battery has a positive electrode containing a positive electrode active material, a negative electrode, and a non-aqueous electrolyte. The positive electrode active material includes a lithium-containing oxide obtained by ion exchanging a portion of sodium contained in a cobalt-containing oxide with lithium, the cobalt-containing oxide represented by the formula Liₓ₁Na_{y1}Co_{α}Mn_{β}M_{z}O_{γ} where: M is at least one element selected from the group consisting of Mg, Ni, Zr, Mo, W, Al, Cr, V, Ce, Ti, Fe, K, Ca, and In; 0<x1<0.45; 0.66<y1<0.75; 0.62≦α≦0.72; 0.28≦β≦0.38; 0≦z≦0.1; and 1.9≦γ≦2.1.

### BACKGROUND OF THE INVENTION

The present invention relates to a non-aqueous electrolyte secondary battery and a method of manufacturing the battery.

Currently, non-aqueous electrolyte secondary batteries are widely used as secondary batteries capable of delivering high energy density.

Conventionally, a lithium-transition metal composite oxide such as LiCoO₂ is typically used as a positive electrode material for non-aqueous electrolyte secondary batteries. An example of the negative electrode material typical used is a carbon material capable of intercalating and deintercalating lithium. An example of the non-aqueous electrolyte typically used is an electrolyte in which a lithium salt such as LiBF₄ or LiPF₆ is dissolved in an organic solvent such as ethylene carbonate or diethyl carbonate.

In recent years, the power consumption of mobile devices which use the non-aqueous electrolyte secondary batteries has been increasing, as the mobile devices have tended to be equipped with more features and functions. Accordingly, demand has been escalating for non-aqueous electrolyte secondary batteries that achieve further higher energy density.

In order to obtain a non-aqueous electrolyte secondary battery with high energy density, it is necessary to increase the capacity of the positive electrode active material. In view of this, Patent Documents 1 and 2 as well as Non Patent Documents 1 to 3 in the following citation list, for example, have proposed various types of positive electrode active materials with high capacity and methods of manufacturing such active materials.

The lithium-containing layered compound LiCoO₂ widely used as the positive electrode active material at present has an O3 crystal structure belonging to the space group R-3m. The crystal structure of this lithium-containing layered compound LiCoO₂ tends to deteriorate, resulting in degradation in reversibility, when the potential is set at 4.5 V (vs. Li/Li⁺) or higher and about 50% of the lithium in the crystal structure is extracted. For this reason, the maximum discharge capacity density that can be achieved when using the lithium-containing layered compound with an O3 structure, such as LiCoO₂, is about 160 mAh/g.

In order to further increase the discharge capacity density, it is necessary to allow the positive electrode active material to retain a stable structure even when a greater amount of lithium is extracted. To obtain a lithium-containing layered compound with such a structure, it has been proposed to manufacture a lithium-containing layered compound by ion exchanging a sodium-containing layered compound.

For example, Patent Document 1 listed below describes a method of manufacturing a sodium-containing lithium-containing oxide by ion exchanging part of sodium contained in a sodium-containing oxide with lithium. The publication also discloses, as a lithium-containing oxide manufactured by this method, a lithium-containing oxide belonging to the space group P6₃mc and/or the space group Cmca and represented by the compositional formula Li_{A}Na_{B}MnₓCo_{y}O_{2±α} where 0.5≦A≦1.2, 0≦B≦0.01, 0.40≦x≦0.55, 0.40≦y≦0.55, 0.80≦x+y≦1.10, and 0≦α≦0.3.

The crystal structure of the lithium-containing oxide described in Patent Document 1 does not easily degrade even when a large amount of lithium is extracted therefrom by charging it to a high potential. Patent Document 1 states that by using this lithium-containing oxide as the positive electrode active material, a high charge-discharge capacity density can be obtained.

### CITATION LIST

### Patent Literature

[Patent Document 1] Japanese Published Unexamined Patent Application No. 2009-32681
[Patent Document 2] Japanese Published Unexamined Patent Application No. 2002-220231

### Non Patent Literature

[Non Patent Document 1] J. Electrochem. Soc., 149 (8) (2002) A1083.
[Non Patent Document 2] J. Electrochem. Soc., 147 (7) (2000) 2478.
[Non Patent Document 3] Solid State Ionics, 144 (2001) 263.

### SUMMARY OF INVENTION

In order to increase the capacity of the non-aqueous electrolyte secondary battery without increasing the size, it is important to increase the discharge capacity per unit volume as well as the discharge capacity per unit weight. In order to increase the discharge capacity per unit volume, it is necessary to increase the true density of the positive electrode active material. In other words, in order to increase the capacity of the non-aqueous electrolyte secondary battery without increasing the size, it is necessary that the positive electrode active material have a high discharge capacity per unit weight and at the same time have a high true density.

However, with the positive electrode active material made of the lithium-containing oxide disclosed in Patent Document 1 it is difficult to have a sufficiently high true density. In fact, the true density of the positive electrode active material described in Patent Document 1 is 4.44 g/cm³, which is far lower than the true density of commonly-used LiCoO₂ having an O3 structure, 5 g/cm³.

Moreover, although Patent Document 1 states that the true density can be increased to 5.0 g/cm³, the present inventors have found as a result of assiduous studies that the true density cannot be increased sufficiently with the positive electrode active material made of the lithium-containing oxide according to Patent Document 1 because the content of manganese in the composition is high while the content of cobalt therein is low. That is, the present inventors have found that when the content of manganese in the composition is high and the content of cobalt therein is low, the true density cannot be increased sufficiently significantly even by ion exchanging a portion of sodium contained in the cobalt-containing oxide with lithium.

The present invention has been accomplished in view of the foregoing and other problems, and it is an object of the invention to provide a non-aqueous electrolyte secondary battery that has a small size but achieves a high capacity.

The first non-aqueous electrolyte secondary battery according to the present invention relates to a non-aqueous electrolyte secondary battery comprising a positive electrode containing a positive electrode active material, a negative electrode, and a non-aqueous electrolyte. The positive electrode active material comprises a lithium-containing oxide obtained by ion exchanging a portion of sodium contained in a cobalt-containing oxide with lithium, the cobalt-containing oxide represented by the formula Liₓ₁Na_{y1}Co_{α}Mn_{β}M_{z}O_{γ} where: M is at least one element selected from the group consisting of Mg, Ni, Zr, Mo, W, Al, Cr, V, Ce, Ti, Fe, K, Ca, and In; 0≦x1≦0.45; 0.66<y1<0.75; 0.62≦α≦0.72; 0.28≦β≦0.38; 0≦z≦0.1; and 1.9≦γ≦2.1.

The method, according to the invention, of manufacturing a non-aqueous electrolyte secondary battery relates to a method of manufacturing a non-aqueous electrolyte secondary battery comprising a positive electrode containing a positive electrode active material, a negative electrode, and a non-aqueous electrolyte. In the method, according to the invention, of manufacturing a non-aqueous electrolyte secondary battery, the positive electrode active material is manufactured by ion exchanging a portion of sodium contained in a cobalt-containing oxide with lithium, the cobalt-containing oxide represented by the formula Liₓ₁Na_{y1}Co_{α}Mn_{β}M_{z}O_{γ} where: M is at least one element selected from the group consisting of Mg, Ni, Zr, Mo, W, Al, Cr, V, Ce, Ti, Fe, K, Ca, and In; 0<x1<0.45; 0.66<y1<0.75; 0.62≦α≦0.72; 0.28≦β≦0.38; 0≦z≦0.1; and 1.9≦γ≦2.1.

In the present invention, it is preferable that the positive electrode active material be a lithium-containing oxide represented by the formula Liₓ₂Na_{y2}Co_{α}Mn_{β}M_{z}O_{γ}, where: M is at least one element selected from the group consisting of Mg, Ni, Zr, Mo, W, Al, Cr, V, Ce, Ti, Fe, K, Ca, and In; 0.66<x2<1; 0<y2≦0.01; 0.62≦α≦0.72; 0.28≦β≦0.38; 0≦z≦0.1; and 1.9≦γ≦2.1.

In the present invention, the lithium-containing oxide as the positive electrode active material is produced by ion exchanging a portion of sodium contained in the cobalt-containing oxide with lithium. For this reason, the crystal structure of the lithium-containing oxide does not easily degrade even when a large amount of lithium is extracted by charging it to a high potential. Therefore, a high discharge capacity per unit weight can be obtained.

Moreover, the cobalt-containing oxide for producing the lithium-containing oxide as the positive electrode active material has a high manganese content and a low cobalt content. Therefore, a high true density can be obtained by ion exchanging a portion of sodium contained in the cobalt-containing oxide with lithium.

As described above, in the present invention, the positive electrode contains a positive electrode active material comprising a lithium-containing oxide that has a high discharge capacity per unit weight and also a high true density. Therefore, the invention makes it possible to obtain a non-aqueous electrolyte secondary battery that has a small size but a high capacity.

In the present invention, the cobalt-containing oxide for producing the lithium-containing oxide contains Li. When the cobalt-containing oxide does not contain Li, in other words, when x1=0, high true density cannot be obtained. The use of a cobalt-containing oxide containing Li as the cobalt-containing oxide for producing the lithium-containing oxide makes it possible to obtain high true density. However, if the amount of Li contained in the cobalt-containing oxide is too large, the proportion of the Li introduced by the ion exchanging is low in the Li contained in the total of the Li contained in the lithium-containing oxide. Consequently, the capacity density per unit volume of the positive electrode active material is decreased. For this reason, x1 should be in the range 0<x1<0.45.

In the present invention, if the amount of Na contained in the cobalt-containing oxide is too low, the proportion of the Li introduced by the ion exchanging is low in the total of the Li contained in the lithium-containing oxide. Consequently, the capacity density per unit volume of the positive electrode active material is decreased. On the other hand, the amount of Na contained in the cobalt-containing oxide is too large, hygroscopicity is too high, making the synthesis difficult. For this reason, y1 should be in the range 0.66<y1<0.75.

In the present invention, if the amount of Co is small and the amount of Mn is large in the cobalt-containing oxide, the true density cannot be increased significantly even when a portion of sodium contained in the cobalt-containing oxide is ion exchanged with lithium. In other words, in order to increase the true density significantly by ion exchanging a portion of sodium contained in the cobalt-containing oxide with lithium, it is necessary that the amount of Co be large and the amount of Mn be small in the cobalt-containing oxide. Nevertheless, if the amount of Co is too large and the amount of Mn is too small in the cobalt-containing oxide, the lithium-containing oxide is allowed to contain impurities during the ion exchanging. For this reason, α should be in the range 0.67±0.05 (0.62≦α≦0.72), and β should be in the range 0.33±0.05 (0.28≦β≦0.38). This enables the lithium-containing oxide to have a high true density.

In the present invention, the cobalt-containing oxide may contain at least one element M selected from the group consisting of Mg, Ni, Zr, Mo, W, Al, Cr, V, Ce, Ti, Fe, K, Ca, and In. By adding the element(s) M to the cobalt-containing oxide, thermal stability during charge can be improved. Nevertheless, if the content of M in the cobalt-containing oxide is too high, the average discharge potential may be lowered or the true density may be decreased, and the advantage of the high capacity positive electrode active material may be lessened. For this reason, z should be set within the range 0≦z≦0.1.

In the present invention, if the content of oxygen contained in the cobalt-containing oxide is too high or too low, the crystal structure of the cobalt-containing oxide may not be kept stable. For this reason, γ should be set within the range 2±0.1.

In the first non-aqueous electrolyte secondary battery according to the present invention, it is preferable that the positive electrode active material have a true density of 4.8 g/cm³ or higher, more preferably 5.0 g/cm³ or higher. Although the higher the true density of the positive electrode active material, the better, it is believed that the limit is about 5.1 g/cm³ in terms of composition and structure. For this reason, it is preferable that the positive electrode active material have a true density of 5.1 g/cm³ or less.

The second non-aqueous electrolyte secondary battery according to the present invention relates to a non-aqueous electrolyte secondary battery comprising a positive electrode containing a positive electrode active material, a negative electrode, and a non-aqueous electrolyte. In the second non-aqueous electrolyte secondary battery according to the invention, the positive electrode active material comprises a lithium-containing oxide represented by the formula Liₓ₂Na_{y2}Co_{α}Mn_{β}M_{z}O_{γ}, where: M is at least one element selected from the group consisting of Mg, Ni, Zr, Mo, W, Al, Cr, V, Ce, Ti, Fe, K, Ca, and In; 0.66<x2<1; 0<y2≦0.01; 0.62≦α≦0.72; 0.28≦β≦0.38; 0≦z≦0.1; and 1.9≦γ≦2.1, and the lithium-containing oxide having a true density of 4.8 g/cm³ or higher.

In the second non-aqueous electrolyte secondary battery according to the invention, the lithium-containing oxide as the positive electrode active material may be produced by ion exchanging a portion of sodium contained in the cobalt-containing oxide with lithium. For this reason, the crystal structure of the lithium-containing oxide cannot easily degrade even when a large amount of lithium is extracted by charging it to a high potential. Therefore, a high discharge capacity per unit weight can be obtained.

Moreover, the positive electrode active material has a high true density, 4.8 g/cm³ or higher. Therefore, the invention makes it possible to obtain a non-aqueous electrolyte secondary battery that has a small size but a high capacity.

In the present invention, if the content of Li in the lithium-containing oxide as the positive electrode active material is too low, the amount of lithium that can be involved in charge-discharge reactions becomes too small, causing the theoretical capacity to be decreased. On the other hand, if the content of Li in the lithium-containing oxide is too high, lithium atoms enter the transition metal sites, also causing the theoretical capacity to be decreased. Therefore, it is preferable that the amount of lithium be in the range 0.66<x2<1.

If the content of Na in the lithium-containing oxide is too high, sodium insertion and deinsertion may cause degradation of the structure. For this reason, y2 should be set within the range 0<y2≦0.01. If y2≦0.01, Na may not be detected by an XRD measurement.

If the content of Co in the lithium-containing oxide is too low and the content of Mn is too high, sufficiently high true density cannot be obtained. In order to obtain sufficiently high true density, it is necessary that the content of Co should be high and the content of Mn should be low in the lithium-containing oxide. Nevertheless, if the content of Co in the lithium-containing oxide is too high and the content of Mn is too low, a transition to a structure that does not yield stable characteristics is observed in a process of charging it to 4.6 V (vs. Li/Li⁺) or higher. For this reason, a should be set within the range 0.67±0.05, and 13 should be set within the range 0.33±0.05.

In the present invention, the lithium-containing oxide may contain at least one element M selected from the group consisting of Mg, Ni, Zr, Mo, W, Al, Cr, V, Ce, Ti, Fe, K, Ca, and In. By adding the element(s) M to the lithium-containing oxide, thermal stability during charge can be improved. Nevertheless, if the content of M in the lithium-containing oxide is too high, the average discharge potential may be lowered or the true density may be decreased, and the advantage of the high capacity positive electrode active material may be lessened. For this reason, z should be set within the range 0≦z≦0.1.

If the content of oxygen contained in the lithium-containing oxide is too high or too low, the crystal structure of the lithium-containing oxide may not be kept stable. For this reason, γ should be set within the range 2±0.1.

In the second non-aqueous electrolyte secondary battery according to the present invention, if the true density of the positive electrode active material is 4.8 g/cm³ or less, it is difficult to obtain a sufficiently high discharge capacity per unit volume. It is preferable that the positive electrode active material have a true density of 4.8 g/cm³ or higher, more preferably 5.0 g/cm³ or higher. Although the higher the true density of the positive electrode active material, the better, it is believed that the limit is about 5.1 g/cm³ in terms of composition and structure. For this reason, it is preferable that the positive electrode active material have a true density of 5.1 g/cm³ or less.

In the present invention, it is preferable that the lithium-containing oxide contain: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca. According to this configuration, the stability of the crystal structure of the positive electrode active material can be further enhanced when a large amount of lithium is extracted therefrom by charging it to a high potential. Therefore, a higher discharge capacity per unit weight can be obtained. It is more preferable that the lithium-containing oxide contain all of the lithium-containing oxide having an O₂ structure belonging to the space group P6₃mc, the lithium-containing oxide having a T2 structure belonging to the space group Cmca, and the lithium-containing oxide having a crystal structure belonging to the space group C2/m or C2/c.

The term “O2 structure” means a crystal structure in which a lithium atom exists at the center of the oxygen octahedron and two kinds of stacks comprising the layer including oxygen and the layer including transition metals exist per unit cell.

The term “O3 structure” means a crystal structure in which a lithium atom exists at the center of the oxygen octahedron and three kinds of stacks comprising the layer including oxygen and the layer including transition metals exist per unit cell. A commonly-known example of the lithium-containing oxide having an O2 structure belonging to the space group P6₃mc is LiCoO₂.

The term “T2 structure” means a crystal structure in which a lithium atom exists at the center of the oxygen tetrahedron structure and two kinds of stacks comprising the layer including oxygen and the layer including exist per unit cell. Commonly-known examples of the substances having a T2 structure belonging to the space group Cmca include Li_{2/3}Co_{2/3}Mn_{1/3}O₂ and Li_{0.7}Ni_{1/3}Mn_{2/3}O₂.

Commonly-known examples of the lithium-containing oxides having a crystal structure belonging to the space group C2/m or C2/c include solid solutions of a layered rock-salt structure and Li₂MnO₃, such as Li₂Mn₁₋ₓMₓO₃ and Li_{1.2}Mn_{0.54}Ni_{0.13}Co_{0.13}O₂, in which a portion of manganese in Li₂MnO₃ or Li₂MnO₃ is substituted by another metal.

The way in which the lithium-containing oxide having a crystal structure belonging to the space group C2/m or C2/c and the at least one lithium-containing oxide selected from the lithium-containing oxide having an O2 structure and the lithium-containing oxide having a T2 structure exist is not particularly limited. That is, the lithium-containing oxide may be a solid solution or a mixture of the lithium-containing oxide having a crystal structure belonging to the space group C2/m or C2/c and at least one lithium-containing oxide selected from the lithium-containing oxide having an O2 structure and the lithium-containing oxide having a T2 structure.

When the lithium-containing oxide contains the lithium-containing oxide having an O2 structure belonging to the space group P6₃mc, it is preferable that the lithium-containing oxide having an O2 structure belonging to the space group P6₃mc have a lattice constant a within the range of from 2.805 Å to less than 2.815 Å and a lattice constant c within the range of from 9.76 Å to less than 9.975 Å. In this case, a high capacity positive electrode active material that has a stable structure and a high true density can be obtained.

When the lithium-containing oxide contains the lithium-containing oxide having a T2 structure belonging to the space group Cmca, it is preferable that the lithium-containing oxide having a T2 structure have a lattice constant a within the range of from 2.800 Å to less than 2.815 Å, a lattice constant b within the range of from 4.849 Å to less than 4.860 Å, and a lattice constant c within the range of from 9.770 Å to less than 9.982 Å. This makes it possible to obtain a high capacity positive electrode active material that has a high true density and shows a stable structure even when a large amount of lithium is extracted from the structure.

In the present invention, the positive electrode is not particularly limited as long as it contains the positive electrode active material according to the invention. For example, the positive electrode may have a current collector made of an electrically conductive foil such as a metal foil or an alloy foil, and a positive electrode mixture layer formed on the surface of the current collector, and the positive electrode mixture layer may contain the above-described positive electrode active material according to the invention. In addition, the positive electrode mixture layer may other materials such as a binder and a conductive agent, in addition to the positive electrode active material according to the invention.

Examples of the binder that may be contained in the positive electrode mixture layer include polytetrafluoroethylene, polyvinylidene fluoride, polyethylene oxide, polyvinyl acetate, polymethacrylate, polyacrylate, polyacrylonitrile, polyvinyl alcohol, styrene-butadiene rubber, and carboxymethylcellulose. These binders may be used either alone or in combination.

If the content of the binder is too high in the positive electrode mixture layer, a high energy density may not be obtained because the relative content of the positive electrode active material becomes too low in the positive electrode mixture layer. For this reason, it is preferable that the content of the binder in the positive electrode mixture layer be from 0 mass % to 30 mass %, more preferably from 0 mass % to 20 mass %, still more preferably from 0 mass % to 10 mass %.

When the positive electrode active material has sufficiently high conductivity, it is not always necessary to add a conductive agent to the positive electrode mixture layer. On the other hand, when the conductivity of the positive electrode active material is low, it is preferable to add a conductive agent to the positive electrode mixture layer. Examples of the conductive agent that may be added to the positive electrode mixture layer include electrically conductive oxides, electrically conductive carbides, and electrically conductive nitrides. Examples of the electrically conductive oxides include tin oxide and indium oxide. Examples of the electrically conductive carbides include tungsten carbide and zirconium carbide. Examples of the electrically conductive nitrides include titanium nitride and tantalum nitride.

If the amount of the conductive agent is too small when adding an conductive agent to the positive electrode mixture layer, the conductivity of the positive electrode mixture cannot be enhanced sufficiently. On the other hand, when the amount of the conductive agent is too large, a high energy density may not be obtained because the relative content of the positive electrode active material may become too small in the positive electrode mixture. For this reason, it is preferable that the content of the conductive agent in the positive electrode mixture layer be from 0 mass % to 30 mass %, more preferably from 0 mass % to 20 mass %, still more preferably from 0 mass % to 10 mass %.

In the present invention, the negative electrode is not particularly limited. The negative electrode may be formed of lithium, silicon, carbon, tin, germanium, aluminum, lead, indium, gallium, lithium-containing alloys, silicon alloys, and carbon or silicon materials in which lithium has been absorbed in advance, for example.

In the present invention, the non-aqueous electrolyte is not particularly limited. Examples of the solvent for the non-aqueous electrolyte include cyclic carbonates, chain carbonates, esters, cyclic ethers, chain ethers, nitriles, and amides. Examples of the cyclic carbonates include ethylene carbonate, propylene carbonate, and butylene carbonate. It is also possible to use, as the solvent for the non-aqueous electrolyte, a cyclic carbonate in which part or all of the hydrogen groups of one of the foregoing cyclic carbonates is/are fluorinated. Examples of the cyclic carbonate in which part of all of the hydrogen groups is/are fluorinated include trifluoropropylene carbonate and fluoroethyl carbonate. Examples of the chain carbonates include dimethyl carbonate, ethyl methyl carbonate, diethyl carbonate, methyl propyl carbonate, ethyl propyl carbonate, and methyl isopropyl carbonate. It is also possible to use, as the solvent for the non-aqueous electrolyte, a chain carbonate in which part or all of the hydrogen groups of one of the foregoing cyclic carbonic esters is/are fluorinated. Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether. Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether. An example of the nitriles is acetonitrile. An example of the amides is dimethylformamide. It is also possible to use a mixture of any two or more of the above-listed solvents.

Examples of the lithium salt to be added to the non-aqueous electrolyte include LiBF₄, LiPF₆, LiCF₃SO₃, LiC₄F₉SO₃, LiN(CF₃SO₂)₂, LiN(C₂F₅SO₂)₂, LiAsF₆, lithium difluoro(oxalate)borate, and mixtures thereof.

The present invention makes it possible to provide a non-aqueous electrolyte secondary battery that has a small size but a high capacity.

### BRIEF DESCRIPTION OF THE DRAWINGS

FIG. 1 is a graph showing the results of XRD measurements for a cobalt-containing oxide used in Example 1.

FIG. 2 is a graph showing the results of an XRD analysis for a lithium-containing oxide used in Example 1.

FIG. 3 is a schematic cross-sectional view illustrating a test cell prepared in Example 1.

FIG. 4 is a graph showing the charge-discharge curves of the test cell prepared in Example 1.

FIG. 5 is a graph showing the results of XRD measurements for lithium-containing oxides of Examples 1 to 3 and Comparative Examples 1 and 2.

### DESCRIPTION OF EMBODIMENTS

Hereinbelow, the present invention is described in further detail based on embodiments thereof. It should be construed, however, that the present invention is not limited to the following embodiments, and various changes and modifications are possible without departing from the scope of the invention.

### Example 1

First, using sodium nitrate (NaNO₃), lithium carbonate (Li₂CO₃), cobalt (II, III) oxide (Co₃O₄), and manganese (III) oxide (Mn₂O₃), a cobalt-containing oxide represented as Li_{0.1}Na_{0.2}Co_{0.62}Mn_{0.33}O₂. More specifically, the just-mentioned starting materials were weighed so as to be a desired composition ratio, and they were mixed sufficiently. This mixture was placed in a furnace, and heated and kept at 900° C. for 10 hours, to prepare the cobalt-containing oxide.

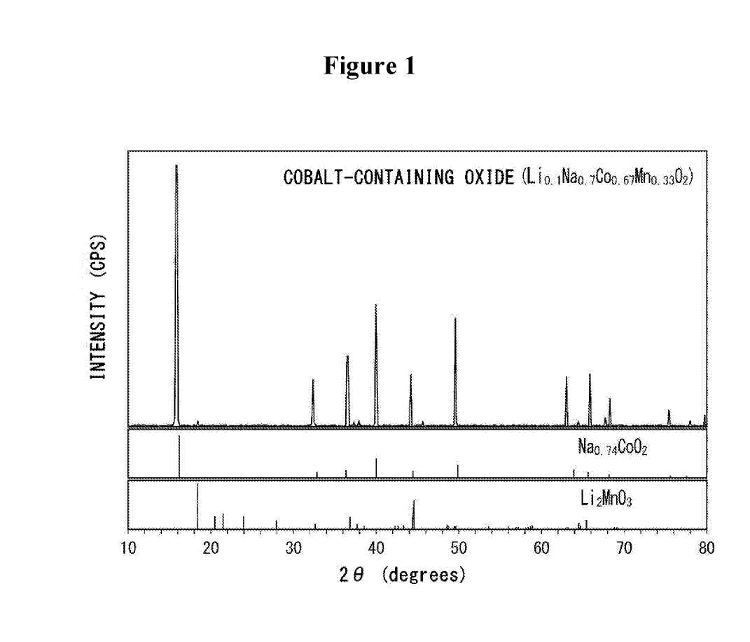

The results of XRD measurements for the prepared cobalt-containing oxide are shown in FIG. 1, together with the results of XRD measurements for Na_{0.74}CoO₂ (PDF #87-0274) and Li₂MnO₃ (PDF #73-0152). In the present example, the radiation source for the XRD measurements used was CuK_{α}.

Next, a portion of sodium contained in the cobalt-containing oxide was ion exchanged with lithium, using a fused salt bed in which 88 mol % of lithium nitrate (LiNO₃) and 12 mol % of lithium chloride (LiCl) were mixed. Thereby, a lithium-containing oxide represented as Li_{0.77}Na_{0.001}Co_{0.67}Mn_{0.33}O₂ was prepared.

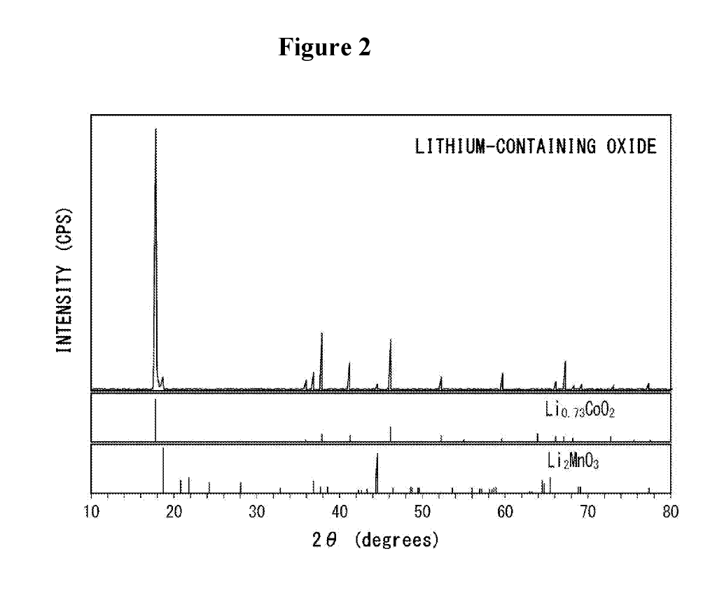

Specifically, only 5 g of a cobalt-containing oxide represented as Li_{0.1}Na_{0.7}Co_{0.66}Mn_{0.34}O₂ was weighed, and 5 times equivalent weight of the cobalt-containing oxide of the molten salt bed was added to the foregoing cobalt-containing oxide, followed by setting it aside at 280° C. for 10 hours. Thereafter, solid matter was washed with water and then dried. Thereby, the lithium-containing oxide represented as Li_{0.77}Na_{0.001}Co_{0.67}Mn_{0.33}O₂ was prepared. The results of XRD measurements for the prepared lithium-containing oxide are shown in FIG. 2, together with the results of XRD measurements for Li_{0.73}CoO₂ (PDF #37-1162) and Li₂MnO₃ (PDF 73-0152).

In addition, the true density of the obtained lithium-containing oxide was measured by a dry density measurement method by a constant volume expansion method using helium gas.

Next, using this lithium-containing oxide as the positive electrode active material, a positive electrode was prepared. More specifically, 80 mass % of the lithium-containing oxide, 10 mass % of acetylene black as a conductive agent, and 10 mass % of polyvinylidene fluoride as a binder agent were mixed with N-methyl-2-pyrrolidone to obtain a slurry. The resultant slurry was applied onto both sides of an aluminum foil, and the resultant material was vacuum dried at 110° C. and then formed into a predetermined shape. Thus, the positive electrode was prepared.

Next, a negative electrode was prepared by cutting lithium metal into a predetermined size. Likewise, a reference electrode was prepared by cutting lithium metal into a predetermined size.

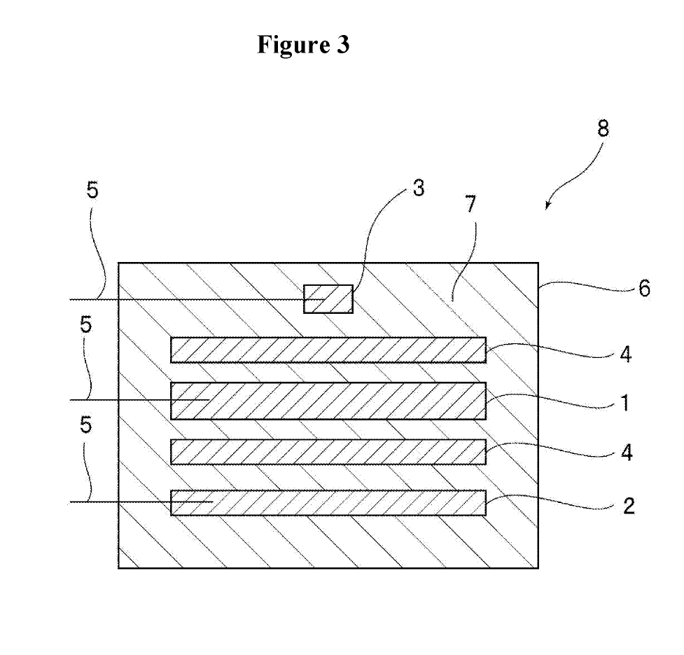

Then, a test cell 8 with the structure as shown in FIG. 3 was prepared in an inert atmosphere, using the positive electrode 1, the negative electrode 2, and the reference electrode 3 prepared in the foregoing manner in addition to separators 4 made of polyethylene, leads 5, a laminate case 6, and a non-aqueous electrolyte 7. The non-aqueous electrolyte 7 used was prepared as follows. Ethylene carbonate and diethyl carbonate were mixed in a proportion of 30:70 volume % to prepare an electrolyte solution. Then, lithium hexafluorophosphate (LiPF₆) was added at a concentration of 1.0 mol/L to the solution.

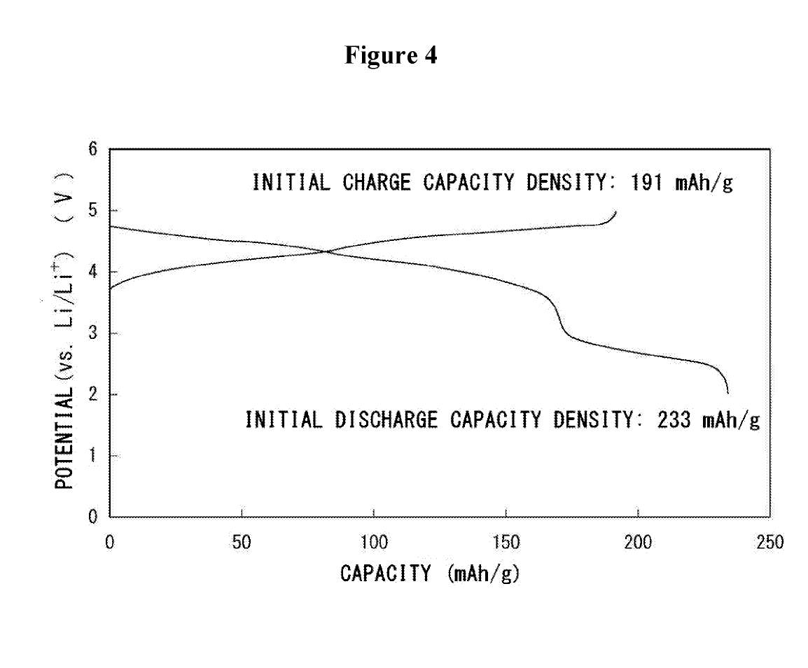

The obtained test cell 8 was subjected to a charge-discharge test in which the test cell was charged and discharged within the range of from 2.0 V to 5.0 V (vs. Li/Li⁺) at a current density of 0.1 mA/cm³. FIG. 4 shows the charge-discharge curves of the test cell of the present example.

### Example 2

A lithium-containing oxide and a test cell were prepared in the same manner as described in Example 1 above, except that a cobalt-containing oxide represented as Li_{0.2}Na_{0.7}Co_{0.67}Mn_{0.33}O₂ was used, and the charge-discharge characteristics of the test cell were evaluated.

### Example 3

A lithium-containing oxide and a test cell were prepared in the same manner as described in Example 1 above, except that a cobalt-containing oxide represented as Li_{0.3}Na_{0.7}Co_{0.67}Mn_{0.33}O₂ was used, and the charge-discharge characteristics of the test cell were evaluated.

### Comparative Example 1

A lithium-containing oxide and a test cell were prepared in the same manner as described in Example 1 above, except that a cobalt-containing oxide represented as Na_{0.7}Co_{0.67}Mn_{0.33}O₂, which did not contain Li, was used, and the charge-discharge characteristics of the test cell were evaluated.

### Comparative Example 2

A lithium-containing oxide and a test cell were prepared in the same manner as described in Example 1 above, except that a cobalt-containing oxide represented as Li_{0.4}Na_{0.7}Co_{0.62}Mn_{0.33}O₂ was used, and the charge-discharge characteristics of the test cell were evaluated.

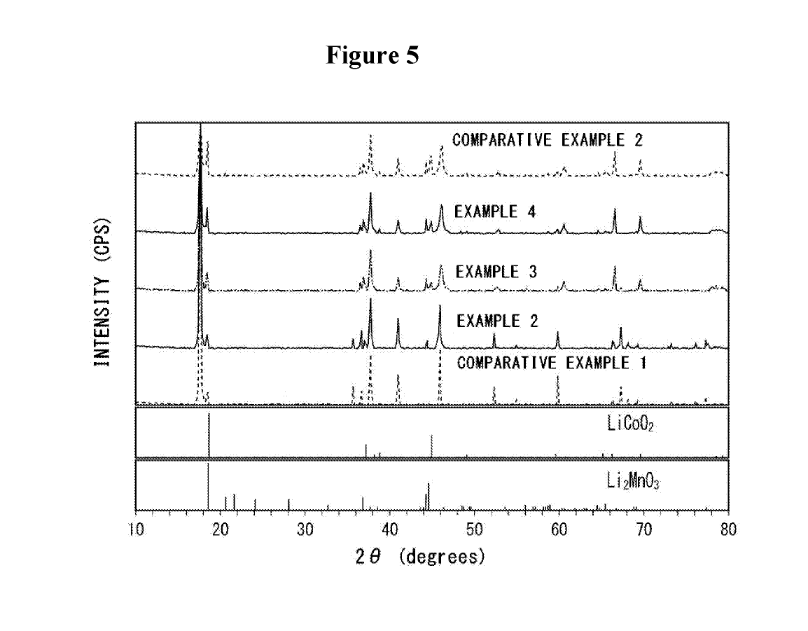

FIG. 5 shows the results of XRD measurements for the lithium-containing oxides of Examples 1 to 3 and Comparative Examples 1 and 2, together with the results of XRD measurements for LiCoO₂ (PDF #70-2685) and Li₂MnO₃ (PDF 73-0152).

As shown in FIG. 5, the XRD profile of the lithium-containing oxide of Comparative Example 1 almost matches the XRD profile of the T2 structure. This indicates that the lithium-containing oxide of Comparative Example 1 is composed of a lithium-containing oxide having a T2 structure.

The XRD profile of the lithium-containing oxide of Comparative Example 2 was such that the XRD profile of an O2 structure and that of a material having a crystal structure belonging to the space group C2/m or C2/c were combined. This indicates that the lithium-containing oxide of Comparative Example 2 contains the lithium-containing oxide having an O2 structure and the lithium-containing oxide having a crystal structure belonging to the space group C2/m or C2/c.

In all the Examples 1 to 3, the XRD profiles of the lithium-containing oxides were such that the XRD profile of the T2 structure, that of the O2 structure, and that of a material having a crystal structure belonging to the space group C2/m or C2/c were combined. However, the XRD profile of the lithium-containing oxide of Example 1 was most similar to the XRD profile of the T2 structure, the XRD profile of the lithium-containing oxide of Example 3 was most similar to the XRD profile of the O₂ structure, and the XRD profile of the lithium-containing oxide of Example 2 was midway between them. This demonstrates that each of the lithium-containing oxides of Examples 1 to 3 contains the lithium-containing oxide having a T2 structure, the lithium-containing oxide having an O2 structure, and the lithium-containing oxide having a crystal structure belonging to the space group C2/m or C2/c. It is also demonstrated that the content of the lithium-containing oxide having a T2 structure is highest in Example 1 and lowest in Example 3. It is also demonstrated that the content of the lithium-containing oxide having an O2 structure is highest in Example 3 and lowest in Example 1.

Table 1 below gives a summary of the preparation compositions of Examples and Comparative Examples and the composition ratios (of the cobalt-containing oxide and the lithium-containing oxide) of the samples actually prepared obtained by elementary analysis. The composition ratios were determined by atomic emission spectroscopy for lithium and sodium, and ICP emission spectroscopy for manganese and cobalt. In Table 1, the composition ratios are shown taking the sum of cobalt and manganese as 1 and oxygen as 2. In addition, Table 2 below gives a summary of the structures of the oxides contained in the respective lithium-containing oxides of Examples and Comparative Examples, the true densities, and the initial discharge capacity densities.

TABLE 1

| | Preparation | Cobalt-containing | Lithium-containing |
|---|---|---|---|
| | composition | oxide | oxide |
| Ex. 1 | Li_{0.1}Na_{0.7}Co_{0.67}Mn_{0.33}O₂ | Li_{0.10}Na_{0.70}Co_{0.66}Mn_{0.34}O₂ | Li_{0.77}Na_{0.001}Co_{0.67}Mn_{0.33}O₂ |
| Ex. 2 | Li_{0.2}Na_{0.7}Co_{0.67}Mn_{0.33}O₂ | Li_{0.20}Na_{0.70}Co_{0.66}Mn_{0.34}O₂ | Li_{0.85}Na_{0.001}Co_{0.67}Mn_{0.33}O₂ |
| Ex. 3 | Li_{0.3}Na_{0.7}Co_{0.67}Mn_{0.33}O₂ | Li_{0.31}Na_{0.70}Co_{0.66}Mn_{0.34}O₂ | Li_{0.9}Na_{0.002}Co_{0.67}Mn_{0.33}O₂ |
| Comp. | Na_{0.7}Co_{0.67}Mn_{0.33}O₂ | Na_{0.72}Co_{0.66}Mn_{0.34}O₂ | Li_{0.71}Na_{0.001}Co_{0.66}Mn_{0.34}O₂ |
| Ex. 1 | | | |
| Comp. | Li_{0.4}Na_{0.7}Co_{0.67}Mn_{0.33}O₂ | Li_{0.41}Na_{0.69}Co_{0.66}Mn_{0.34}O₂ | Li_{0.94}Na_{0.002}Co_{0.67}Mn_{0.33}O₂ |
| Ex. 2 | | | |

TABLE 2

| | | Structure of | | Initial | Initial |
|---|---|---|---|---|---|
| | | oxide contained | True | discharge | discharge |
| | Lithium-containing | in the lithium- | density | capacity | capacity |
| | oxide | containing oxide | (g/cm³) | density (Ah/L) | density (mAh/g) |
| Ex. 1 | Li_{0.77}Na_{0.001}Co_{0.67}Mn_{0.33}O₂ | T2 + O2 + | 5.04 | 1174 | 233 |
| | | C2/m or C2/c | | | |
| Ex. 2 | Li_{0.85}Na_{0.001}Co_{0.67}Mn_{0.33}O₂ | T2 + O2 + | 5.02 | 1150 | 229 |
| | | C2/m or C2/c | | | |
| Ex. 3 | Li_{0.9}Na_{0.002}Co_{0.67}Mn_{0.33}O₂ | T2 + O2 + | 4.82 | 1065 | 221 |
| | | C2/m or C2/c | | | |
| Comp. | Li_{0.71}Na_{0.001}Co_{0.66}Mn_{0.34}O₂ | T2 | 4.66 | 1049 | 225 |
| Ex. 1 | | | | | |
| Comp. | Li_{0.94}Na_{0.002}Co_{0.67}Mn_{0.33}O₂ | O2 + | 4.52 | 1012 | 224 |
| Ex. 2 | | C2/m or C2/c | | | |

As shown in Table 1, both of the Examples 1 through 3 and Comparative Examples 1 and 2 showed high initial discharge capacity density per unit weight, 220 mAh/g or higher. This is believed to be because in both of Examples 1 through 3 and Comparative Examples 1 and 2, the lithium-containing oxide contains at least one of the lithium-containing oxide having a T2 structure belonging to the space group Cmca and the lithium-containing oxide having an O2 structure belonging to the space group P6₃mc, as shown in Table 2, so the crystal structure of the lithium-containing oxide does not easily degrade even when it is charged to a high potential and large amount of lithium is extracted therefrom.

However, in Comparative Examples 1 and 2, the initial discharge capacity density per unit volume was low, 1050 Åh/L or less, because the true density is low, 4.7 g/cm³ or less. In contrast, in Examples 1 through 3, the true density was high, 4.8 g/cm³ or higher, so the initial discharge capacity density per unit volume was accordingly high, 1060 Åh/L or higher.

From the above-described results, it is demonstrated that the capacity of the non-aqueous electrolyte secondary battery can be increased without increasing the size by using, as the positive electrode active material, the lithium-containing oxide obtained by ion exchanging a portion of sodium contained in the cobalt-containing oxide having the composition according to the present invention with lithium.

In addition, it is demonstrated that the cobalt-containing oxide needs to contain Li in order to obtain a high true density because Comparative Example 1, in which the cobalt-containing oxide does not contain Li, shows a true density of only 4.66 g/cm³.

Moreover, Comparative Example 2, in which the cobalt-containing oxide contained Li but the total content (x1+y1) of Li and Na in the cobalt-containing oxide was equal to or greater than 1 and the content of Li (x2) in the lithium-containing oxide was equal to or greater than 1, also showed a low true density, 4.52 g/cm³. This demonstrates that it is necessary that, in order to obtain a high true density, the total content (x1+y1) of Li and Na be set to less than 1 and the content of Li (x2) be set to less than 1 in the lithium-containing oxide.

Furthermore, from comparisons of Examples 1 through 3 and Comparative Example 2, it is appreciated that the less the content of Li (x1) in the cobalt-containing oxide, the higher the true density is, and also the higher the initial discharge capacity density per unit volume. This is believed to be because, when the content of Li (x1) is lower, the proportion of the Li originating from the Li contained in the cobalt-containing oxide becomes less and the proportion of the Li introduced by the ion exchanging becomes higher in the lithium-containing oxide, allowing the lithium-containing oxide to have a strong crystal structure because of the lithium extraction. Therefore, it is preferable that the ratio [x1/(x1+y1)] of the content of the Li (x1) in the cobalt-containing oxide with respect to the total sum (x1+y1) of the contents of Na and Li in the cobalt-containing oxide be 0.35 or less, more preferably 0.3 or less, still more preferably 0.25 or less, yet more preferably 0.23 or less.

Table 3 below shows the lattice constants of Examples 1 to 3 and Comparative Examples 1 and 2, defined by T2 structure or O2 structure.

TABLE 3

| | Lattice constant | | | Lattice constant | | |
|---|---|---|---|---|---|---|
| | defined by | | | defined by | | |
| | T2 structure | | | O2 structure | | |
| | a | b | c | a | b | c |
| Ex. 1 | 2.813 | 4.853 | 9.970 | 2.810 | 2.810 | 9.968 |
| Ex. 2 | 2.806 | 4.854 | 9.784 | 2.805 | 2.805 | 9.782 |
| Ex. 3 | 2.805 | 4.854 | 9.773 | 2.805 | 2.805 | 9.769 |
| Comp. | 2.812 | 4.848 | 9.982 | — | — | — |
| Ex. 1 | | | | | | |
| Comp. | — | — | — | 2.804 | 2.804 | 9.755 |
| Ex. 2 | | | | | | |

The results shown in Table 3 indicate that it is desirable that the lithium-containing oxide having an O2 structure belonging to the space group P6₃mc have a lattice constant a within the range of from 2.805 Å to less than 2.815 Å and a lattice constant c within the range of from 9.76 Å to less than 9.975 Å. In a substance with a lattice constant a of less than 2.805 Å and a lattice constant c of less than 9.76 Å, the structure of retaining lithium is stable, so the structure tends to become instable when lithium is extracted. Consequently, a large amount of lithium cannot be extracted, and the capacity density is low. On the other hand, a substance with a lattice constant a of 2.815 Å or greater and a lattice constant c of 9.975 Å or greater results in a low true density.

It is desirable that the lithium-containing oxide having a T2 structure belonging to the space group Cmca have a lattice constant a within the range of from 2.800 Å to less than 2.815 Å, a lattice constant b within the range of from 4.849 Å to less than 4.860 Å, and a lattice constant c within the range of from 9.770 Å to less than 9.982 Å.

The materials having a lattice constant a of less than 2.800 Å or equal to or greater than 2.815 Å or a lattice constant c of less than 9.770 Å or equal to or greater than 9.982 Å have instable structure, and therefore, they can neither yield a high capacity density nor show good cycle performance. Moreover, the materials having a lattice constant b of less than 4.849 Å or equal to or greater than 4.860 Å result in a low true density.

### Comparative Example 3

A lithium-containing oxide and a test cell were prepared in the same manner as described in Comparative Example 1 above, except that a cobalt-containing oxide represented as Na_{0.7}Co_{0.83}Mn_{0.17}O₂, which contained a high content of Co and a low content of Mn, was used, and the charge-discharge characteristics of the test cell were evaluated.

Note that in the present comparative example, a mixture of 61 mol % of lithium nitrate (LiNO₃) and 39 mol % of lithium hydroxide (LiOH.H₂O) was used as the molten salt bed. 5 g of the cobalt-containing oxide was added to 5 times equivalent weight of the cobalt-containing oxide of the molten salt bed, and the resultant material was set aside at 200° C. for 10 hours.

### Comparative Example 4

A lithium-containing oxide and a test cell were prepared in the same manner as described in Comparative Example 2 above, except that a cobalt-containing oxide represented as Li_{0.1}Na_{0.7}Co_{0.83}Mn_{0.17}O₂, containing Li, was used, and the charge-discharge characteristics of the test cell were evaluated.

Table 4 below shows the compositional formulae of the cobalt-containing oxides and the compositional formulae and the true densities of the lithium-containing oxides of Comparative Examples 3 and 4, along with the compositional formulae of the cobalt-containing oxides and the compositional formulae and the true densities of the lithium-containing oxides of Example 1 and Comparative Example 1.

TABLE 4

| | Preparation | Lithium-containing | True density |
|---|---|---|---|
| | composition | oxide | (g/cm³) |
| Ex. 1 | Li_{0.1}Na_{0.7}Co_{0.67}Mn_{0.33}O₂ | Li_{0.77}Na_{0.001}Co_{0.67}Mn_{0.33}O₂ | 5.04 |
| Comp. | Na_{0.7}Co_{0.67}Mn_{0.33}O₂ | Li_{0.71}Na_{0.001}Co_{0.66}Mn_{0.34}O₂ | 4.66 |
| Ex. 1 | | | |
| Comp. | Na_{0.7}Co_{0.83}Mn_{0.17}O₂ | Li_{0.86}Na_{0.009}Co_{0.83}Mn_{0.17}O₂ | 4.91 |
| Ex. 3 | | | |
| Comp. | Li_{0.1}Na_{0.7}Co_{0.83}Mn_{0.17}O₂ | Li_{0.89}Na_{0.009}Co_{0.83}Mn_{0.17}O₂ | 4.92 |
| Ex. 4 | | | |

From comparison between Example 1 and Comparative Example 1, in which the content of Co is low and the content of Mn is high, it is demonstrated that the true density of the resultant lithium-containing oxide can be made significantly higher by adding Li to the cobalt-containing oxide. On the other hand, from comparison between Comparative Examples 3 and 4, it is appreciated that the true densities of the resultant lithium-containing oxides turned out to be similar in the cases where the content of Co was high and the content of Mn was low, even when Li was added to the cobalt-containing oxide. These results demonstrate that the advantageous effect of increasing the true density by allowing the cobalt-containing oxide to contain Li is obtained only when the contents of Co and Mn in the cobalt-containing oxide are in accordance with the present invention. The reason why in Comparative Example 3, the content of the lithium becomes higher than the preparation amount of sodium is that when the content of Co becomes high, cobalt is reduced during the ion exchanging and extra lithium is inserted therein.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

### REFERENCE SIGNS LIST

1—Positive electrode
2—Negative electrode
3—Reference electrode
4—Separator
5—Lead
6—Laminate case
7—Non-aqueous electrolyte
8—Test cell

What is claimed is:

1. A non-aqueous electrolyte secondary battery comprising: a positive electrode containing a positive electrode active material; a negative electrode; and a non-aqueous electrolyte, wherein the positive electrode active material comprises a lithium-containing oxide obtained by ion exchanging a portion of sodium contained in a cobalt-containing oxide with lithium, the cobalt-containing oxide represented by the formula Liₓ₁Na_{y1}Co_{α}Mn_{β}M_{z}O_{γ}, where: M is at least one element selected from the group consisting of Mg, Ni, Zr, Mo, W, Al, Cr, V, Ce, Ti, Fe, K, Ca, and In; 0<x1<0.45; 0.66<y1<0.75; 0.62≦α≦0.72; 0.28≦β≦0.38; 0≦z≦0.1; and 1.9≦γ≦2.1.

2. The non-aqueous electrolyte secondary battery according to claim 1, wherein the lithium-containing oxide is represented by the formula Liₓ₂Na_{y2}Co_{α}Mn_{β}M_{z}O₇, where: M is at least one element selected from the group consisting of Mg, Ni, Zr, Mo, W, Al, Cr, V, Ce, Ti, Fe, K, Ca, and In; 0.66<x2<1; 0<y2≦0.01; 0.62≦α≦0.72; 0.28≦β≦0.38; 0≦z≦0.1; and 1.9≦γ≦2.1.

3. The non-aqueous electrolyte secondary battery according to claim 1, wherein the positive electrode active material has a true density of 4.8 g/cm³ or higher.

4. The non-aqueous electrolyte secondary battery according to claim 2, wherein the positive electrode active material has a true density of 4.8 g/cm³ or higher.

5. A non-aqueous electrolyte secondary battery comprising: a positive electrode containing a positive electrode active material; a negative electrode; and a non-aqueous electrolyte, the positive electrode active material comprises a lithium-containing oxide represented by the formula Liₓ₂Na_{y2}Co_{α}Mn_{β}M_{z}O_{γ}, where: M is at least one element selected from the group consisting of Mg, Ni, Zr, Mo, W, Al, Cr, V, Ce, Ti, Fe, K, Ca, and In; 0.66<x2<1; 0≦y2≦0.01; 0.62≦α≦0.72; 0.28≦β≦0.38; 0≦z≦0.1; and 1.9≦γ≦2.1, and the lithium-containing oxide having a true density of 4.8 g/cm³ or higher.

6. The non-aqueous electrolyte secondary battery according to claim 3, wherein the positive electrode active material has a true density of 5.1 g/cm³ or less.

7. The non-aqueous electrolyte secondary battery according to claim 4, wherein the positive electrode active material has a true density of 5.1 g/cm³ or less.

8. The non-aqueous electrolyte secondary battery according to claim 5, wherein the positive electrode active material has a true density of 5.1 g/cm³ or less.

9. The non-aqueous electrolyte secondary battery according to claim 1, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

10. The non-aqueous electrolyte secondary battery according to claim 2, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

11. The non-aqueous electrolyte secondary battery according to claim 3, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

12. The non-aqueous electrolyte secondary battery according to claim 4, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

13. The non-aqueous electrolyte secondary battery according to claim 5, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

14. The non-aqueous electrolyte secondary battery according to claim 6, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

15. The non-aqueous electrolyte secondary battery according to claim 7, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

16. The non-aqueous electrolyte secondary battery according to claim 8, wherein the lithium-containing oxide contains: a lithium-containing oxide having a crystal structure belonging to the space group C2/m or C2/c; and at least one lithium-containing oxide selected from a lithium-containing oxide having an O2 structure belonging to the space group P6₃mc and a lithium-containing oxide having a T2 structure belonging to the space group Cmca.

17. The non-aqueous electrolyte secondary battery according to claim 16, wherein:
the lithium-containing oxide comprises a lithium-containing oxide having an O2 structure belonging to the space group P6₃mc; and
the lithium-containing oxide having an O2 structure belonging to the space group P6₃mc has a lattice constant a within the range of from 2.805 Å to less than 2.815 Å and a lattice constant c within the range of from 9.76 Å to less than 9.975 Å.

18. The non-aqueous electrolyte secondary battery according to claim 17, wherein:
the lithium-containing oxide comprises a lithium-containing oxide having a T2 structure belonging to the space group Cmca; and
the lithium-containing oxide having a T2 structure belonging to the space group
Cmca has a lattice constant a within the range of from 2.800 Å to less than 2.815 Å, a lattice constant b within the range of from 4.849 Å to less than 4.860 Å, and a lattice constant c within the range of from 9.770 Å to less than 9.982 Å.

19. The non-aqueous electrolyte secondary battery according to claim 18, wherein the lithium-containing oxide is a solid solution or a mixture of a lithium-containing oxide having a crystal structure belonging to the space group C2/m or C2/c and at least one lithium-containing oxide selected from a lithium-containing oxide having an O2 structure belonging to the space group P6₃mc and a lithium-containing oxide having a T2 structure belonging to the space group Cmca.

20. A method of manufacturing a non-aqueous electrolyte secondary battery having a positive electrode containing a positive electrode active material, a negative electrode, and a non-aqueous electrolyte, the method comprising: preparing the positive electrode active material by ion exchanging a portion of sodium contained in a lithium-containing oxide with lithium, the lithium-containing oxide represented by the formula Liₓ₁Na_{y1}Co_{α}Mn_{β}M_{z}O₇, where: M is at least one element selected from the group consisting of Mg, Ni, Zr, Mo, W, Al, Cr, V, Ce, Ti, Fe, K, Ca, and In; 0<x1<0.45; 0.66<y1<0.75; 0.62≦α≦0.72; 0.28≦β≦0.38; 0≦z≦0.1; and 1.9≦γ≦2.1.
